(19) United States
(12) Patent Application Publication
(10) Pub. No.: US 2026/0092588 A1
(43) Pub. Date: Apr. 2, 2026

(54) IGNITION DEVICE

(71) Applicant: SUZUKI MOTOR CORPORATION, Hamamatsu-shi (JP)

(72) Inventors: Shinichi YAMADA, Hamamatsu-shi (JP); Yoshiaki MATSUURA, Hamamatsu-shi, Shizuoka (JP)

(73) Assignee: SUZUKI MOTOR CORPORATION, Hamamatsu-shi (JP)

(21) Appl. No.: 19/284,205

(22) Filed: Jul. 29, 2025

(30) Foreign Application Priority Data
Sep. 30, 2024 (JP) 2024-170878

(51) Int. Cl. F02P 3/02; F02M 35/16; F02P 13/00

(52) U.S. Cl. CPC F02P 3/02; F02M 35/162; F02P 13/00

(57) ABSTRACT

An ignition device for a straddle-type vehicle in which a fuel tank is supported on an upper side of a pair of left and right tank rails of a vehicle body frame and in which an engine is supported on a lower side of the pair of left and right tank rails. The ignition device includes an ignition plug provided in the engine and configured to ignite an air-fuel mixture, an ignition coil configured to apply an ignition voltage to the ignition plug, and a plug cord configured to connect the ignition plug and the ignition coil. The ignition coil is located below the pair of left and right tank rails and located on a lateral side of a cylinder head cover of the engine, in a top view.

### CROSS-REFERENCE TO RELATED APPLICATIONS

This application is based on and claims priority under 35 USC 119 from Japanese Patent Application No. 2024-170878 filed on Sep. 30, 2024, the entire content of which is incorporated herein by reference.

### TECHNICAL FIELD

The present invention relates to an ignition device.

### BACKGROUND ART

As an ignition device for a straddle-type vehicle, an ignition device is known in which an ignition coil is supported above an engine and below a main frame (for example, see JP2022-167406A). In the engine described in JP2022-167406A, a pair of support portions protrude from a cylinder head cover, and a pair of flanges protruding from the ignition coil are screwed to the pair of support portions. A plug cap of an ignition plug is provided on one side surface of a cylinder head in the vehicle width direction, and the plug cap is connected to the ignition coil via a plug cord. In this way, the ignition coil is supported above the engine, so that the ignition coil is brought close to the ignition plug.

In the ignition device described in JP2022-167406A, it is necessary to form a fuel tank so as not to interfere with the ignition coil. When the size of the fuel tank is reduced to avoid the ignition coil, the capacity of the fuel tank may not be sufficiently ensured. Although the capacity can be ensured by expanding the fuel tank in the height direction and the vehicle width direction, the size of the vehicle increases, and the fuel tank interferes with the legs of the rider, making it difficult to take an appropriate riding position.

### SUMMARY OF INVENTION

Aspect of non-limiting embodiments of the present disclosure relates to provide an ignition device capable of bringing an ignition coil close to an ignition plug while ensuring the capacity of a fuel tank.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an ignition device for a straddle-type vehicle in which a fuel tank is supported on an upper side of a pair of left and right tank rails of a vehicle body frame and in which an engine is supported on a lower side of the pair of left and right tank rails, the ignition device including:
an ignition plug provided in the engine and configured to ignite an air-fuel mixture;
an ignition coil configured to apply an ignition voltage to the ignition plug; and
a plug cord configured to connect the ignition plug and the ignition coil,
in which the ignition coil is located below the pair of left and right tank rails and located on a lateral side of a cylinder head cover of the engine, in a top view.

### BRIEF DESCRIPTION OF DRAWINGS

Exemplary embodiment(s) of the present invention will be described in detail based on the following figures, wherein:

FIG. 1 is a left side view of a straddle-type vehicle according to the present embodiment;

FIG. 2 is a left side view of the periphery of an engine according to the present embodiment;

FIG. 3 is a top view of the periphery of the engine according to the present embodiment; and

FIG. 4 is a front view of the periphery of the engine according to the present embodiment.

### DESCRIPTION OF EMBODIMENTS

In a straddle-type vehicle according to an aspect of the present invention, a fuel tank is supported on an upper side of a pair of left and right tank rails of a vehicle body frame, and an engine is supported on a lower side of the pair of left and right tank rails. In an ignition device of the straddle-type vehicle, an ignition plug and an ignition coil are connected by a plug cord, and an ignition voltage is applied from the ignition coil to the ignition plug to ignite an air-fuel mixture. The ignition plug is provided in the engine, and the ignition coil is provided below the pair of left and right the tank rail and located on a lateral side of a cylinder head cover of the engine, in a top view. The ignition coil is separated downward from the fuel tank, so that the capacity of the fuel tank is sufficiently ensured without reducing the size of the fuel tank or expanding the height dimension and the width dimension of the fuel tank. The ignition coil is located on the lateral side of the cylinder head cover, so that the ignition coil is brought close to the ignition plug (provided in the engine). Therefore, the ignition coil can be brought close to the ignition plug while ensuring the capacity of the fuel tank.

### EMBODIMENT

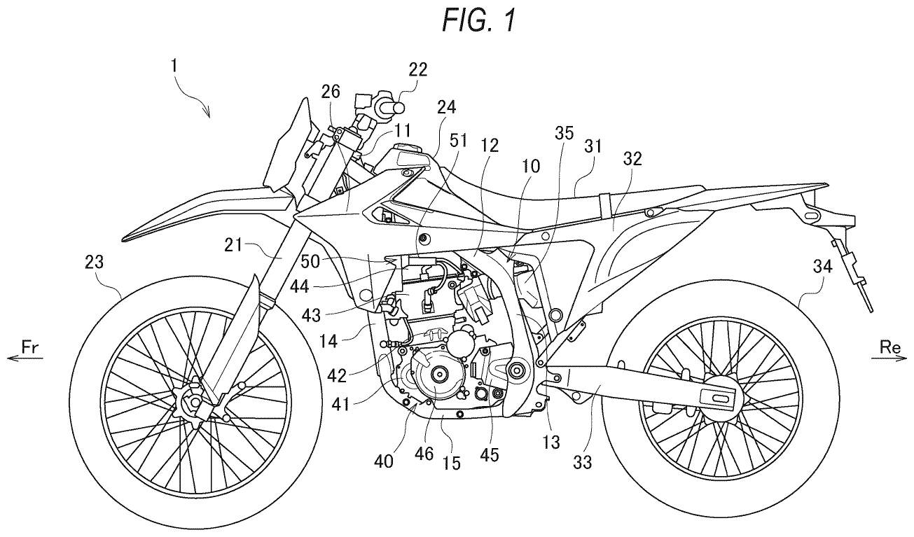

Hereinafter, a straddle-type vehicle according to the present embodiment will be described with reference to the accompanying drawings. FIG. 1 is a left side view of the straddle-type vehicle according to the present embodiment. In the following drawings, an arrow Fr indicates a vehicle front side, an arrow Re indicates a vehicle rear side, an arrow L indicates a vehicle left side, and an arrow R indicates a vehicle right side.

As shown in FIG. 1, a straddle-type vehicle 1 is implemented by mounting various components such as an engine 40 and an electrical system on a vehicle body frame 10. A pair of tank rails 12 extend obliquely rearward and downward from a head pipe 11 of the vehicle body frame 10, splitting into left and right parts, and a pair of body frames 13 extend downward from the rear portions of the pair of tank rails 12. A down frame 14 extends downward from the head pipe 11, and an under loop 15 bent rearward is connected to the lower portion of the down frame 14. The rear end portion of the under loop 15 is connected to the lower portions of the pair of body frames 13, so that the vehicle body frame 10 is formed into a cradle shape.

A front fork 21 is steerably supported on the head pipe 11 via a steering shaft (not shown). A handle 22 is provided at the upper portion of the front fork 21, and a front wheel 23 is rotatably supported on the lower portion of the front fork 21. A fuel tank 24 is placed over the upper portion of the pair of tank rails 12, and the tank rails 12 and the fuel tank 24 are covered by front side covers 26 from the lateral sides. A seat 31 is provided rearward of the fuel tank 24, and a seat frame (not shown) supporting the seat 31 from below is covered by rear side covers 32 from the lateral sides.

A swing arm 33 is swingably supported on the body frame 13. The swing arm 33 extends rearward from the body frame 13, and a rear wheel 34 is rotatably supported at the rear end of the swing arm 33. The engine 40 is a four-stroke single-cylinder engine, and is suspended on the inner side of the vehicle body frame 10 via a suspension bracket (not shown). An air cleaner 35 is provided rearward of a cylinder head 43. In this way, in the straddle-type vehicle 1 according to the present embodiment, the fuel tank 24 is supported on the upper side of the pair of tank rails 12, and the engine 40 is supported on the lower side of the pair of tank rails 12.

Normally, an engine is provided with an ignition device for causing an air-fuel mixture to burn by sparking. Although the ignition coil of the ignition device is brought close to the ignition plug provided in the engine, when the ignition coil is provided inside the vehicle body frame, the ignition coil becomes an obstacle, the inside of the vehicle body frame cannot be used as an installation space for the fuel tank, and the capacity of the fuel tank decreases. If the ignition coil is provided on the front side of the engine, there is no influence on the fuel tank. However, since there is a heat source such as the engine near the ignition coil, it is necessary to take measures against heat for the ignition device, which increases the cost.

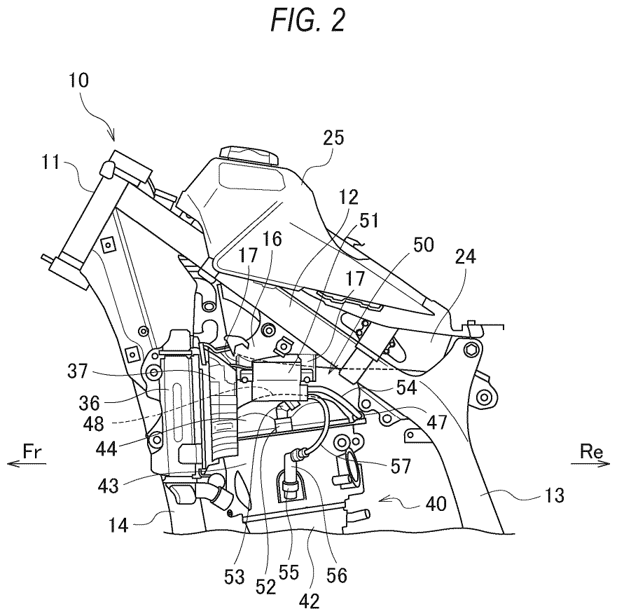

The ignition coil is supported on the tank rail or the cylinder head cover by a bracket or the like. Since the ignition coil is a heavy object, sufficient strength is required to prevent breakage of the bracket, which increases the cost. In the straddle-type vehicle 1 according to the present embodiment, the lateral side of a cylinder head cover 44 below the pair of tank rails 12 is a dead space. Therefore, in an ignition device 50 (see FIG. 2) according to the present embodiment, an ignition coil 51 is supported on a highly rigid bridge 16 (see FIG. 2) of the vehicle body frame 10 using the dead space below one of the pair of tank rails 12.

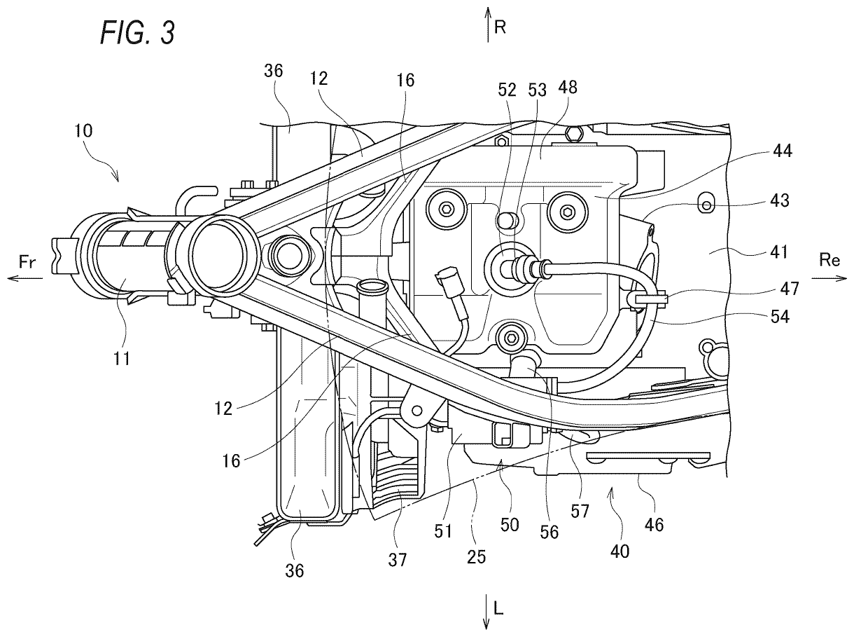

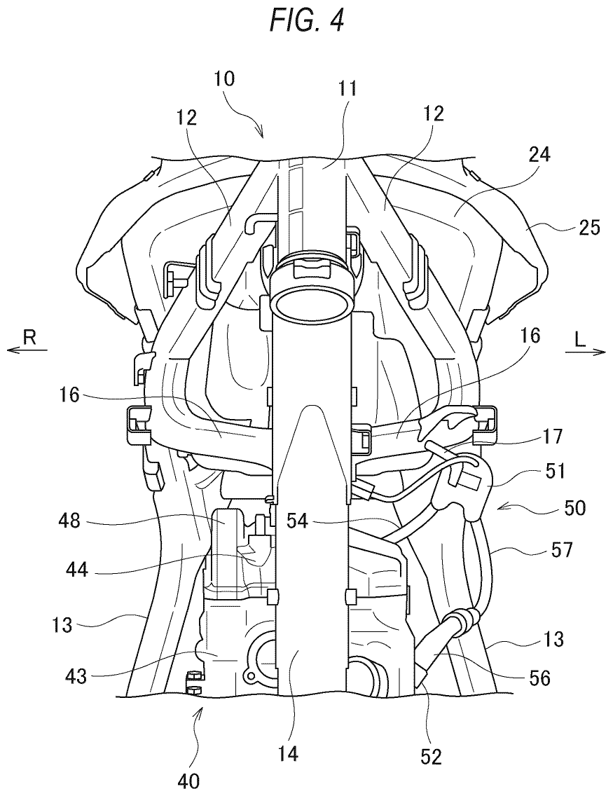

The layout of the ignition device will be described with reference to FIGS. 2 to 4. FIG. 2 is a left side view of the periphery of the engine according to the present embodiment. FIG. 3 is a top view of the periphery of the engine according to the present embodiment. FIG. 4 is a front view of the periphery of the engine according to the present embodiment. In FIG. 3, the fuel tank and the tank cover are indicated by two-dot chain lines. In FIG. 4, the radiator is omitted.

As shown in FIG. 2, in the upper portion of the vehicle body frame 10, the pair of tank rails 12 extend obliquely downward and rearward from the rear side of the upper portion of the head pipe 11, and the single down frame 14 extends downward from the rear side of the lower portion of the head pipe 11. The intermediate portion of the pair of tank rails 12 and the intermediate portion of the down frame 14 are connected via a pair of reinforcing bridges 16. The fuel tank 24 is supported on the pair of tank rails 12, and the upper half portion of the fuel tank 24 is covered with a tank cover 25. The lower half portion of the fuel tank 24 enters the inside of the pair of tank rails 12, and the lower end of the fuel tank 24 is positioned below the bridge 16.

As shown in FIGS. 2 and 3, the engine 40 is suspended from the vehicle body frame 10 by a suspension bracket (not shown) below the bridge 16. A cylinder 42 is provided on the upper surface of a crankcase 41 of the engine 40, the cylinder head 43 is provided on the upper surface of the cylinder 42, and the cylinder head cover 44 is provided on the upper surface of the cylinder head 43. A magneto cover (an engine cover) 46 and a sprocket cover (see FIG. 1) are provided on the left side surface of the crankcase 41. A clutch cover (not shown), a water pump (not shown), and the like are provided on the right side surface of the crankcase 41.

In front of the cylinder head 43, radiators 36 are provided on both lateral sides of the down frame 14 at the center of the vehicle. A radiator fan 37 is attached to the back surface of the radiator 36. The straddle-type vehicle 1 is provided with the ignition device 50 that causes the air-fuel mixture to burn by sparking during the start of the engine 40. The ignition device 50 is implemented by connecting a first ignition plug 52 and a second ignition plug 55 to the ignition coil 51 by plug cords 54 and 57. An ignition voltage is applied to the first ignition plug 52 and the second ignition plug 55 by the ignition coil 51, and the air-fuel mixture is ignited by the first ignition plug 52 and the second ignition plug 55.

The first ignition plug 52 and the second ignition plug 55 are provided in the engine 40. The first ignition plug 52 is provided in the upper portion of the cylinder head 43, and a plug cap 53 of the first ignition plug 52 protrudes upward from the cylinder head cover 44. The second ignition plug 55 is provided on the side portion (the left side portion) of the cylinder head 43, and a plug cap 56 of the second ignition plug 55 protrudes obliquely upward from the cylinder head 43. The first ignition plug 52 and the second ignition plug 55 are located on the same straight line (on the cylinder axis), in the side view. By using the twin plug for the engine 40, the exhaust gas is reduced and the fuel efficiency is improved.

The ignition coil 51 has a rectangular shape in the side view and is positioned below the bridge 16 on one side (the left side). A pair of support portions 17 protrude downward from the bridges 16, and the ignition coil 51 is supported at both ends by the pair of support portions 17. Although the ignition coil 51 is a heavy object, the ignition coil 51 is supported by the bridge 16 having high rigidity, so that a bracket for the ignition coil 51 becomes unnecessary, and the weight and the cost of the vehicle body are reduced. The plug cords 54 and 57 extend from the rear surface of the ignition coil 51 toward the first ignition plug 52 and the second ignition plug 55. The middle portion of one plug cord 54 is supported on a clamp 47 provided in the cylinder head 43, and the shaking of the plug cord 54 is effectively prevented.

As shown in FIG. 2, the ignition coil 51 overlaps the fuel tank 24 in the side view. In this case, the lower portion of the fuel tank 24 bulges to below the bridge 16, and the lower portion of the fuel tank 24 overlaps the upper portion of the ignition coil 51. The capacity is increased by the bulging of the fuel tank 24, and the bulging of the fuel tank 24 in the height direction and the vehicle width direction is prevented, thereby preventing an increase in the size of the vehicle. The ignition coil 51 overlaps the cylinder head cover 44 in the side view. In this case, the lower portion of the ignition coil 51 overlaps a protrusion 48 of the cam chain chamber of the cylinder head cover 44. By using the dead space of the vehicle body frame 10 and the engine 40, a design change of the vehicle is reduced.

The ignition coil 51 is located above the first ignition plug 52 and the second ignition plug 55 on the axis of the first ignition plug 52 and the second ignition plug 55 in the side view. When the ignition coil 51 is brought close to the first ignition plug 52 and the second ignition plug 55, the plug cords 54 and 57 connecting the ignition coil 51 to the first ignition plug 52 and the second ignition plug 55 are shortened, and wiring is facilitated. By shortening the plug cords 54 and 57, the rotation of the plug cap 53 of the first ignition plug 52 and the plug cap 56 of the second ignition plug 55 is prevented. The plug cords 54 and 57 are curved so as to bulge rearward, and the plug cords 54 and 57 do not protrude outward in the height direction or the vehicle width direction.

As shown in FIG. 3, in the top view, the ignition coil 51 is provided on the lateral side (the left side) of the cylinder head cover 44 and on the inner side with respect to the outer surface of the magneto cover 46 in the vehicle width direction. That is, the ignition coil 51 is located between the left side surface of the cylinder head cover 44 and the outer surface of the magneto cover 46. Since the ignition coil 51 does not protrude outward in the vehicle width direction, the ignition coil 51 does not interfere with the leg portion of the rider, and the influence on the riding position is reduced. When the cylinder head cover 44 is removed for tappet adjustment or the like, it is not necessary to remove the ignition coil 51 from the vehicle body frame 10, and the ease of maintenance is improved.

In the top view, the ignition coil 51 is located rearward of the front surface of the cylinder head cover 44 and forward of the rear surface. The ignition coil 51 overlaps the fuel tank 24 (see FIG. 4), and the ignition coil 51 is covered from above by the tank cover 25 (see FIG. 4). The tank cover 25 and the magneto cover 46 are positioned on the outer side with respect to the ignition coil 51 in the vehicle width direction, and when the vehicle rolls over, the tank cover 25 and the magneto cover 46 first hit the ground, so that the ignition coil 51 is prevented from being damaged. Although the second ignition plug 55 is located directly below the ignition coil 51, the second ignition plug 55 is also prevented from being damaged by the tank cover 25 and the magneto cover 46 when the vehicle rolls over.

The ignition coil 51 is positioned on a straight line extending outward from the center of the first ignition plug 52 in the vehicle width direction, in the top view, and the ignition coil 51 is positioned on a straight line extending from the center of the second ignition plug 55 in the height direction, in the side view. The ignition coil 51 is located substantially directly beside the first ignition plug 52 in the top view, and the ignition coil 51 is located substantially directly above the second ignition plug 55, in the side view, so that the ignition coil 51 is brought close to both the first ignition plug 52 and the second ignition plug 55. The ignition coil 51 is located on the lateral side of the cylinder head cover 44, so that the lower portion of the fuel tank 24 is expanded to the vicinity of the cylinder head cover 44, and the capacity is ensured.

As shown in FIG. 4, in the front view, the ignition coil 51 overlaps the tank rail 12 on one side (the left side). The ignition coil 51 is inclined such that the lower portion thereof is located on the inner side with respect to the upper portion thereof in the vehicle width direction, and the ignition coil 51 extends downward from the bridge 16 on the one side (the left side) and inward in the vehicle width direction. The protrusion of the ignition coil 51 is reduced below the bridge 16, so that the influence on the riding position and the influence on the peripheral components are reduced. Since the ignition coil 51 is separated from the engine serving as a heat source in the vehicle width direction and the height direction, it is not necessary to take measures against heat for the ignition coil 51, and the cost is reduced.

As described above, according to the ignition device 50 in the present embodiment, the ignition coil 51 is separated downward from the fuel tank 24, so that the capacity of the fuel tank 24 is sufficiently ensured without reducing the size of the fuel tank 24 or expanding the height dimension and the width dimension of the fuel tank 24. The ignition coil 51 is located on the lateral side of the cylinder head cover 44, so that the ignition coil 51 is brought close to the ignition plug 52 provided in the engine 40. Therefore, the ignition coil 51 can be brought close to the ignition plug 52 while ensuring the capacity of the fuel tank 24.

In the present embodiment, the twin plug engine has been exemplified. Alternatively, a single plug engine may be used.

In the present embodiment, the radiator is provided in the straddle-type vehicle. Alternatively, an air-cooled engine may be used in the straddle-type vehicle and the radiator may not be provided.

In the present embodiment, the ignition coil overlaps the cylinder head cover in the side view. Alternatively, the ignition coil may overlap the cylinder head in the side view.

The ignition device according to the present embodiment is not limited to being used in the off-road type straddle-type vehicle described above, and may be used in other types of straddle-type vehicles. The straddle-type vehicle is not limited to a general vehicle in which a driver rides on a seat in a posture of straddling the seat, and includes a scooter-type vehicle in which the driver rides on the seat without straddling the seat.

As described above, the first aspect is an ignition device (50) for a straddle-type vehicle (1) in which a fuel tank (24) is supported on an upper side of a pair of left and right tank rails (12) of a vehicle body frame (10) and in which an engine (40) is supported on a lower side of the pair of left and right tank rails, the ignition device including: an ignition plug (a first ignition plug 52 and a second ignition plug 55) provided in the engine and configured to ignite an air-fuel mixture; an ignition coil (51) configured to apply an ignition voltage to the ignition plug; and a plug cord (54, 57) configured to connect the ignition plug and the ignition coil, in which the ignition coil is located below the pair of left and right tank rails and located on a lateral side of a cylinder head cover (44) of the engine in a top view. According to this configuration, the ignition coil is separated downward from the fuel tank, so that the capacity of the fuel tank is sufficiently ensured without reducing the size of the fuel tank or expanding the height dimension and the width dimension of the fuel tank. The ignition coil is located on the lateral side of the cylinder head cover, so that the ignition coil is brought close to the ignition plug provided in the engine. Therefore, the ignition coil can be brought close to the ignition plug while ensuring the capacity of the fuel tank.

A second aspect is directed to the first aspect, in the top view, in which the ignition coil is located on an inner side, in a vehicle width direction, with respect to an outer surface of an engine cover (a magneto cover 46) of the engine. According to this configuration, since the ignition coil does not protrude outward in the vehicle width direction, the ignition coil does not interfere with the leg portion of the rider, and the influence on the riding position is reduced. When the cylinder head cover is removed for tappet adjustment or the like, it is not necessary to remove the ignition coil, and the ease of maintenance is improved.

A third aspect is directed to the first and second aspects, in which the ignition coil overlaps the fuel tank in a side view. According to this configuration, the fuel tank enters the inside of the tank rail, the capacity of the fuel tank is increased, and an increase in the size of the vehicle is prevented.

A fourth aspect is directed to any one of the first to third aspects, in which the ignition coil overlaps the cylinder head cover or a cylinder head (43) of the engine in a side view. According to this configuration, by using the dead space of the vehicle body frame and the engine, a design change of the vehicle is reduced.

A fifth aspect is directed to any one of the first to fourth aspects, in which the ignition coil is located on an axis of the ignition plug in a side view. According to this configuration, the plug cord is shortened, and wiring is facilitated. The influence of the plug cord on the peripheral components is reduced.

A sixth aspect is directed to any one of the first to fifth aspects, in which the plug cord is supported on a clamp (47) provided in a cylinder head of the engine. According to this configuration, the middle portion of the plug cord is supported by the clamp, and the shaking of the plug cord is effectively prevented.

A seventh aspect is directed to any one of the first to sixth aspects, in which a down frame (14) of the vehicle body frame is located in front of the engine, and the down frame and the pair of left and right tank rails are connected via a bridge (16), and in which the ignition coil is supported on a support portion (17) protruding downward from the bridge. According to this configuration, the capacity of the fuel tank is easily ensured by separating the ignition coil downward from the fuel tank. The ignition coil is supported on the bridge having high rigidity, so that a bracket for the ignition coil becomes unnecessary, and the weight and the cost of the vehicle body can be reduced.

Although the present embodiment has been described, a part or all of the embodiment and modification described above may be combined as another embodiment.

The technique according to the present invention is not limited to the embodiment described above, and may be variously changed, replaced, or modified without departing from the gist of the technical concept. Further, the present invention may be implemented by other methods as long as the technical concept can be implemented by the methods through advance of the technique or other derivative techniques. Therefore, the claims cover all embodiments that may fall within the scope of the technical concept.

What is claimed is:

1. An ignition device for a straddle-type vehicle in which a fuel tank is supported on an upper side of a pair of left and right tank rails of a vehicle body frame and in which an engine is supported on a lower side of the pair of left and right tank rails, the ignition device comprising:
an ignition plug provided in the engine and configured to ignite an air-fuel mixture;
an ignition coil configured to apply an ignition voltage to the ignition plug; and
a plug cord configured to connect the ignition plug and the ignition coil,
wherein the ignition coil is located below the pair of left and right tank rails and located on a lateral side of a cylinder head cover of the engine, in a top view.

2. The ignition device according to claim 1,
wherein, in the top view, the ignition coil is located on an inner side, in a vehicle width direction, with respect to an outer surface of an engine cover of the engine.

3. The ignition device according to claim 1,
wherein the ignition coil overlaps the fuel tank, in a side view.

4. The ignition device according to claim 1,
wherein the ignition coil overlaps the cylinder head cover or ta cylinder head of the engine, in a side view.

5. The ignition device according to claim 1,
wherein the ignition coil is located on an axis of the ignition plug, in a side view.

6. The ignition device according to claim 1,
wherein the plug cord is supported on a clamp provided in a cylinder head of the engine.

7. The ignition device according to claim 1,
wherein a down frame of the vehicle body frame is located in front of the engine, and the down frame and the pair of left and right tank rails are connected via a bridge, and
wherein the ignition coil is supported on a support portion protruding downward from the bridge.
